(19) United States
(12) Patent Application Publication
(10) Pub. No.: US 2016/0202789 A1
(43) Pub. Date: Jul. 14, 2016

(54) TOUCH PANEL AND DISPLAY DEVICE INCLUDING THE SAME

(71) Applicant: Samsung Display Co., Ltd., Yongin-city (KR)

(72) Inventors: Yeon Tae Kim, Yongin-si (KR); Young Soo No, Seoul (KR); Hwan-Hee Jeong, Cheonan-si (KR); In Young Han, Cheonan-si (KR)

(21) Appl. No.: 14/798,969

(22) Filed: Jul. 14, 2015

(30) Foreign Application Priority Data
Jan. 9, 2015 (KR) 10-2015-0003676

(51) Int. Cl. G06F 3/044; G06F 3/041

(52) U.S. Cl. CPC G06F 3/044; G06F 3/0412

(57) ABSTRACT

A touch panel includes a substrate, touch electrodes disposed on the substrate, and dummy electrodes disposed on the substrate and between adjacent touch electrodes, in which the dummy electrodes include fragment electrodes.

### CROSS-REFERENCE TO RELATED APPLICATION

This application claims priority from and the benefit of Korean Patent Application No. 10-2015-0003676, filed on Jan. 9, 2015, which is hereby incorporated by reference for all purposes as if fully set forth herein.

### BACKGROUND

1. Field

Exemplary embodiments of the present invention relate to a touch panel including a touch sensor, and a display device including the same.

2. Discussion of the Background

A flat panel display (FPD), such as an organic light emitting diode display (OLED), a liquid crystal display (LCD), an electrophoretic display (EPD), or the like, may include a display panel in which an electric field generating electrode and an electro-optical active layer are formed. As the electro-optical active layer, each panel of the organic light emitting diode display, the liquid crystal display, and the electrophoretic display may include an organic emission layer, a liquid crystal layer, and particles charged with electric charges. The electric field generating electrode may be connected to a switching device such as a thin-film transistor, or the like, to receive a data signal, and the electro-optical active layer may convert the data signal into an optical signal to display an image.

The display devices may include a touch sensing function in addition to an image displaying function by the display panel. The touch sensing function may provide the display device to sense a change in pressure, electric charges, light, or the like, applied to the screen to detect touch information, such as whether or not an object touches the screen, a touch position, and the like, when a user touches a screen using his/her finger, a touch pen, or the like. The display device may receive an image signal based on the touch information.

The touch sensing function may be implemented by a capacitive touch sensor including touch electrodes. In the capacitive touch sensor, the touch electrodes may form a capacitor and sense a change in a capacitance generated at the time of a touch. The touch information may be generated based on the change in the capacitance.

An interval between the touch electrodes may have an influence on touch sensitivity, and dummy electrodes may be formed in order to prevent moirés or patterns of touch electrodes from being viewed due to the interval. A panel forming the touch sensor may be a touch panel (or a touch sensor panel, a touch screen panel, or the like). A display panel having a touch sensor function may also be a touch panel.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments of the present invention provide a touch panel having improved touch sensitivity and optical characteristics.

Additional aspects will be set forth in the detailed description which follows, and, in part, will be apparent from the disclosure, or may be learned by practice of the inventive concept.

According to an exemplary embodiment of the present invention, a touch panel includes a substrate, touch electrodes disposed on the substrate, and dummy electrodes disposed on the substrate and between adjacent touch electrodes, in which the dummy electrodes include fragment electrodes.

The fragment electrodes may have random shapes.

The random shapes may be amorphous.

The random shapes may be random polygonal shapes.

The fragment electrodes may have a size in a range of several micrometers to several tens of micrometers.

The dummy electrodes may include gaps disposed between the fragment electrodes, and the fragment electrodes may be separated from each other by the gaps.

The gaps may have a size of several micrometers.

The dummy electrodes may be divided into domains, and each domain may include the fragment electrodes.

The touch electrodes may include first and second touch electrodes configured to form mutual sensing capacitors, and the dummy electrodes may be disposed between the first and second touch electrodes.

The dummy electrode may include the same material as the first and second touch electrodes, and the dummy electrode may be in an electrically floated state.

According to an exemplary embodiment of the present invention, a display device includes a display panel including pixels, a touch panel including touch sensors, the touch sensors including touch electrodes and dummy electrodes disposed between adjacent touch electrodes, a display controller configured to control the display panel, and a touch controller configured to control the touch panel, in which the dummy electrodes include fragment electrodes.

The fragment electrodes may have random shapes.

The random shapes may be amorphous.

The random shapes may be random polygonal shapes.

The fragment electrodes may have a size in a range of several micrometers to several tens of micrometers.

The dummy electrodes may include gaps disposed between the fragment electrodes, and the fragment electrodes may be separated from each other by the gaps.

The gaps may have a size of several micrometers.

The dummy electrodes may be divided into domains, and each domain may include the fragment electrodes.

The touch electrodes may include first and second touch electrodes configured to form mutual sensing capacitors, and the dummy electrodes may be disposed between the first and second touch electrodes.

According to exemplary embodiments of the present invention, neighboring touch electrodes may be spaced apart from each other by a first interval to improve touch sensitivity and optical visibility by including dummy electrodes that include fragment electrodes disposed between the touch electrodes.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a plan view schematically showing a touch panel according to an exemplary embodiment of the present invention.

FIG. 2 is an enlarged view of part A of FIG. 1.

FIG. 3 is a cross-sectional view taken along line III-III of FIG. 2.

FIG. 4 is an enlarged view of part B of FIG. 2.

FIG. 5 is a cross-sectional view taken along line V-V of FIG. 2.

FIGS. 6 and 7 are diagrams showing part B of FIG. 2, according to exemplary embodiments of the present invention.

FIG. 8 is a waveform diagram showing a signal applied to a touch sensor according to an exemplary embodiment of the present invention.

FIG. 9 is a circuit diagram of the touch sensor and a touch signal processor according to an exemplary embodiment of the present invention.

FIG. 10 is a layout diagram of a display device including the touch panel according to an exemplary embodiment of the present invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

A touch panel including a touch sensor and a display device including the same according to an exemplary embodiment of the present invention will be described in detail with reference to the accompanying drawings.

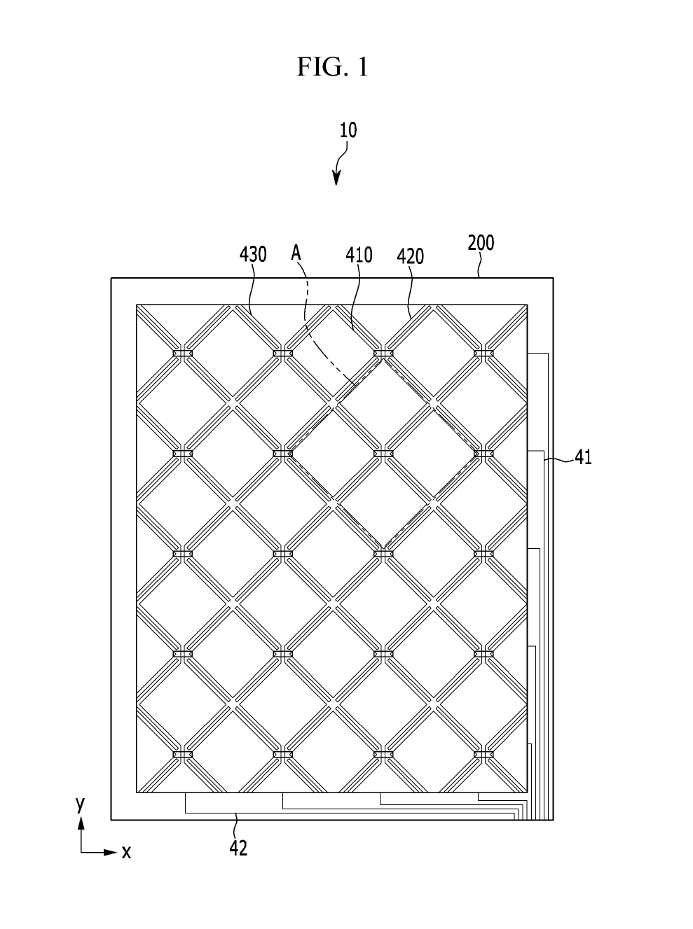

A touch panel according to an exemplary embodiment of the present invention will be described with reference to FIGS. 1 to 4.

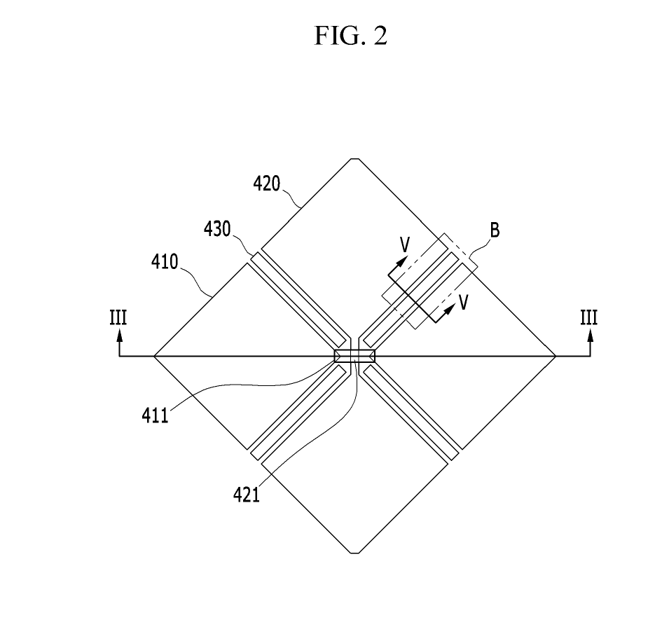

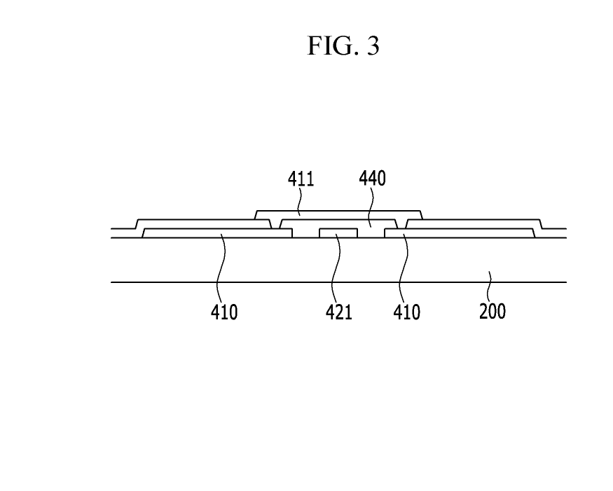

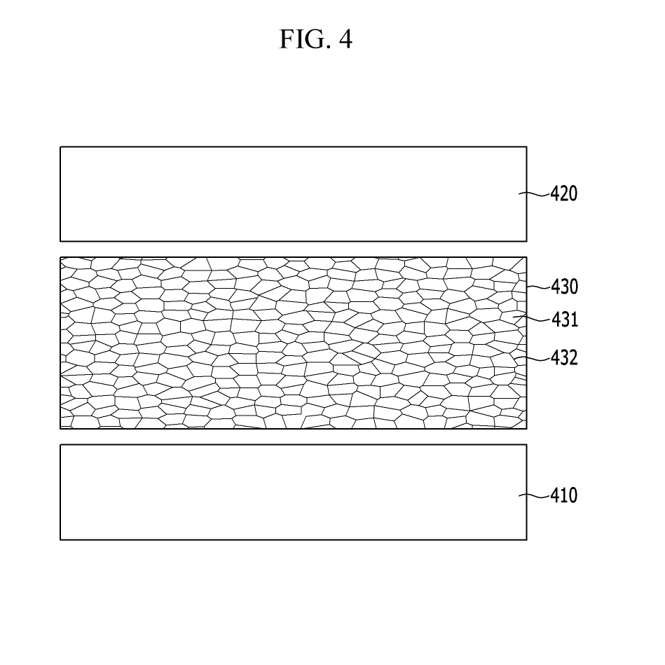

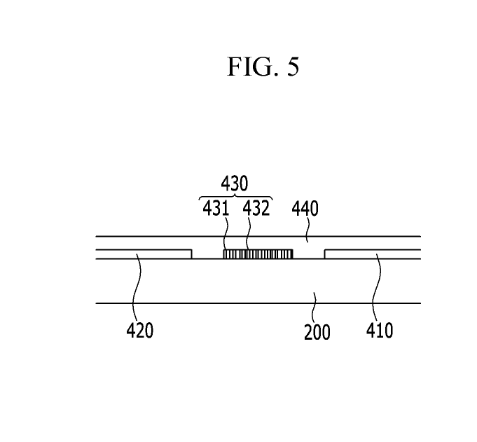

FIG. 1 is a plan view schematically showing a touch panel according to an exemplary embodiment of the present invention, and FIG. 2 is an enlarged view of part A of FIG. 1. FIG. 3 is a cross-sectional view taken along line III-III of FIG. 2, FIG. 4 is an enlarged view of part B of FIG. 2, and FIG. 5 is a cross-sectional view taken along line V-V of FIG. 2.

FIG. 1 illustrates a touch panel 10 according to an exemplary embodiment of the present invention. The touch panel 10 illustrated in FIG. 1 schematically shows an illustrative layout of components of the touch panel 10. Some of the components may not be shown.

The touch panel 10 includes a substrate 200 and touch electrodes 410 and 420 formed on the substrate 200. In an on-cell type touch panel, the touch electrodes 410 and 420 may be formed on an outer surface of a display panel, such as an organic light emitting diode display, an liquid crystal display, or the like. In an in-cell type touch panel, the touch electrodes 410 and 420 may be formed in the display panel. Alternatively, in an add-on type touch panel, the touch electrodes 410 and 420 may be formed on a separate substrate formed of a transparent insulator such as glass, plastic, or the like, and be attached onto the display panel.

The touch electrodes 410 and 420 may form touch sensors sensing a touch. The touch may include a non-contact touch, in which an object hovers over the touch panel, and a contact-touch, in which an object contacts the touch panel.

The touch electrodes 410 and 420 include first touch electrodes 410 and second touch electrodes 420 that are alternately disposed so as not to be overlapped with each other. The first touch electrodes 410 may be disposed in a row direction (an x-axis direction) and a column direction (a y-axis direction), and the second touch electrodes 420 may be disposed in the row direction and the column direction. The touch electrodes 410 and 420 may have a substantially rectangular shape. Alternatively, the touch electrodes 410 and 420 may have a circular shape, an oval shape, or a polygonal shape such as a hexagonal shape, or the like. The touch electrodes 410 and 420 may also include protrusion parts in order to improve sensitivity. The touch electrodes 410 and 420 disposed at edges of the touch panel 10 may have a substantially triangular shape.

At least some of the first touch electrodes 410 arranged in the same row or column may be connected to or separated from each other. Likewise, at least some of the second touch electrodes 420 arranged in the same row or column may also be connected to or separated from each other. As shown in FIG. 1, when the first touch electrodes 410 disposed in the same row are connected to each other, the second touch electrodes 420 disposed in the same column may be connected to each other. The first touch electrodes 410 disposed in each row may be connected to each other by first connectors 411 (see FIG. 2) to form an electrode row, and the second touch electrodes 420 disposed in each column may be connected to each other through second connectors 421 (see FIG. 2) to form an electrode column. According to an exemplary embodiment of the present invention, the first touch electrodes 410 may be connected to each other in the column direction, and the second touch electrodes 420 may be connected to each other in the row direction.

Referring to FIGS. 2 and 3, the first touch electrodes 410 and the second touch electrodes 420 are disposed on the substrate 200, and the second connector 421 connecting neighboring second touch electrodes 420 to each other is also disposed on the substrate 200. The second connector 421 may be integrated with the second touch electrode 420. An insulating layer 440 is disposed on the first touch electrodes 410, the second touch electrodes 420, and the second connector 421. The first connector 411 is disposed on the insulating layer 440, and neighboring first touch electrodes 420 are electrically connected to each other through a contact hole formed in the insulating layer 440. Accordingly, the first connector 411 and the second connector 421 intersect with each other and are physically and electrically separated from each other by the insulating layer 440. An additional insulating layer (not shown) may be disposed on the first connector 411. According to an exemplary embodiment of the present invention, the first connector 411 and the first and second touch electrodes 410 and 420 may be disposed on the same layer, and the second connector 421 may be disposed on the insulating layer 440. The first and second touch electrodes 410 and 420 may be disposed on the same layer, or disposed on different layers.

According to an exemplary embodiment of the present invention, the first connector 411 connecting the neighboring first touch electrodes 410 to each other may be disposed on the substrate 200, the insulating layer 440 may be disposed on the first connector 411, and the first and second touch electrodes 410 and 420 and the second connector 421 may be disposed on the insulating layer 440. The first touch electrodes 410 may be connected to the first connector 411 through a contact hole formed in the insulating layer 440. The touch electrodes may be connected to each other in various ways, as long as the first and second touch electrodes 410 and 420 are insulated from each other.

The first and second touch electrodes 410 and 420 may be formed of a transparent conductor oxide such as an indium tin oxide (ITO) or an indium zinc oxide (IZO), or a conductive material such as a silver nanowire (AgNW), a metal mesh, a carbon nanotube (CNT), or the like. The first and second connectors 411 and 421 may be formed of the same material as that of the first and second touch electrodes 410 and 420 or of the same material as that of first and second touch signal lines 41 and 42 described below. The insulating layer 440 may be formed of an inorganic oxide such as a silicon nitride (SiNx), a silicon oxide (SiOx), or the like.

Referring back to FIG. 1, the first touch signal lines 41 are connected to one ends of each electrode row, and the second touch signal lines 42 are connected to one ends of each electrode column. According to an exemplary embodiment of the present invention, the touch signal lines 41 and 42 may be connected to both ends of the electrode rows and/or the electrode columns. The touch electrodes 410 and 420 may transmit driving signals and output signals to a touch controller (not shown) through the touch signal lines 41 and 42, respectively.

The first and second touch signal lines 41 and 42 may be formed of a metal material such as molybdenum (Mo), silver (Ag), titanium (Ti), copper (Cu), aluminum (Al), molybdenum/aluminum/molybdenum (Mo/Al/Mo), or the like. According to an exemplary embodiment of the present invention, the first and second touch signal lines 41 and 42 may also be formed of a material forming the first and second touch electrodes 410 and 420.

The first and second touch electrodes 410 and 420 neighboring to each other form a mutual sensing capacitor serving as a touch sensor. The mutual sensing capacitor may receive the driving signal through one of the first and second touch electrodes 410 and 420 and output a change of electrical charge caused by a contact of an external object as an output signal through the other touch electrode. For example, the first touch electrode 410 may be an input electrode Tx and the second touch electrode 420 may be an output electrode Rx, or vice versa. One of the first and second touch signal lines 41 and 42 transmits the driving signal from the controller to the first touch electrode 410 or the second touch electrode 420, and the other thereof transmits the output signal from the second touch electrode 420 or the first touch electrode 410 to the touch controller.

According to an exemplary embodiment of the present invention, the first touch electrodes 410 may be separated from each other and the second touch electrodes 420 may be separated from each other, to form independent touch electrodes and connected to touch controllers through corresponding touch signal lines (not shown). In this case, each touch electrodes 410 and 420 may form self-sensing capacitors as touch sensors. The self-sensing capacitor may receive the driving signal to be charged with a predetermined electrical charge, and generate a change of charged electric charge when the external object makes a contact to output an output signal different from the received input signal.

Since capacitance is inversely proportional to distance, when the first and second touch electrodes 410 and 420 neighboring each other form the mutual sensing capacitor, the mutual capacitance of the mutual sensing capacitor may be greater, as the distance between the first and second touch electrodes 410 and 420 decreases, and the mutual capacitance of the mutual sensing capacitor may be smaller, as the distance between the first and second touch electrodes 410 and 420 increases. When the mutual capacitance is large, a change in the mutual capacitance by the touch of the external object is relatively small, such that touch sensitivity may be low. When the mutual capacitance is small, a change in the mutual capacitance by the touch of the external object is relatively large, such that touch sensitivity may be high. Therefore, in order to improve the touch sensitivity, an interval between the first and second touch electrodes 410 and 420 neighboring each other may be spaced apart by a predetermined distance. For example, when the first and second touch electrodes 410 and 420 have a size of several millimeters, an interval between the first and second touch electrodes 410 and 420 may be several hundreds of micrometers.

Since the first and second touch electrodes 410 and 420 are not formed in the interval between the first and second touch electrodes 410 and 420, domains in which the touch electrodes are formed and the interval between the touch electrodes may be differently viewed due to a difference in reflectivity, or the like, therebetween. Accordingly, since patterns of the touch electrodes or moirés are viewed, optical visibility may be deteriorated. As the interval between the touch electrodes is increased, the deterioration of the optical visibility may be increased. As such, dummy electrodes 430 separated from the first and second touch electrodes 410 and 420 are formed in the intervals between the first and second touch electrodes 410 and 420 neighboring to each other. The dummy electrode 430 may be in an electrically floated state. The dummy electrodes 430 may be formed of the same material as that of the first and second touch electrodes 410 and 420, and formed together with the first and second touch electrodes 410 and 420 by forming one transparent conductive material layer and then performing patterning.

Referring to FIGS. 4 and 5, the dummy electrode 430 is formed of fragment electrodes 431 having random shapes. The dummy electrode 430 may have inconsistently shaped tiles (the fragment electrodes configuring the dummy electrode 430), and disposed in a predetermined domain within the interval between the first and second touch electrodes 410 and 420. The dummy electrode 430 may be in a form in which the dummy electrode 430 is irregularly broken finely in random shapes (amorphism). The fragment electrodes 431 having random shapes in the dummy electrode 430 may not have periodicity.

Each fragment electrode 431 forming the dummy electrode 430 may have a size of several micrometers to several tens of micrometers. The sizes of each fragment electrode 431 may not be constant, and may be irregular. The gaps 432 (shown by solid lines) are present between the fragment electrodes 431 within the dummy electrode 430, such that neighboring fragment electrodes 431 may be separated from each other. Sizes of the gaps 432 may be several micrometers, and may not be constant, and may be irregular. The larger the sum of the gaps 432, the larger the empty space within the dummy electrode 430, that may provide smaller mutual capacitance.

Forming the dummy electrode 430 in one electrode may improve optical visibility, but the dummy electrode 430 may increase a mutual capacitance of the first and second touch electrodes 410 and 420 that may lower the touch sensitivity. When the dummy electrode 430 is formed of a plurality of electrodes having constant shapes to improve touch sensitivity, a mutual capacitance may be smaller than that of the dummy electrode formed of one electrode, but constant shapes of the electrodes may be easily seen by eyes, which may deteriorate optical visibility. According to an exemplary embodiment of the present invention, the dummy electrode 430 is formed of the plurality of electrodes to improve the touch sensitivity, and the plurality of electrodes may include randomly shaped fragment electrodes to improve the optical visibility of the touch panel. Accordingly, the touch panel according to the present exemplary embodiment may have improved touch sensitivity and optical visibility.

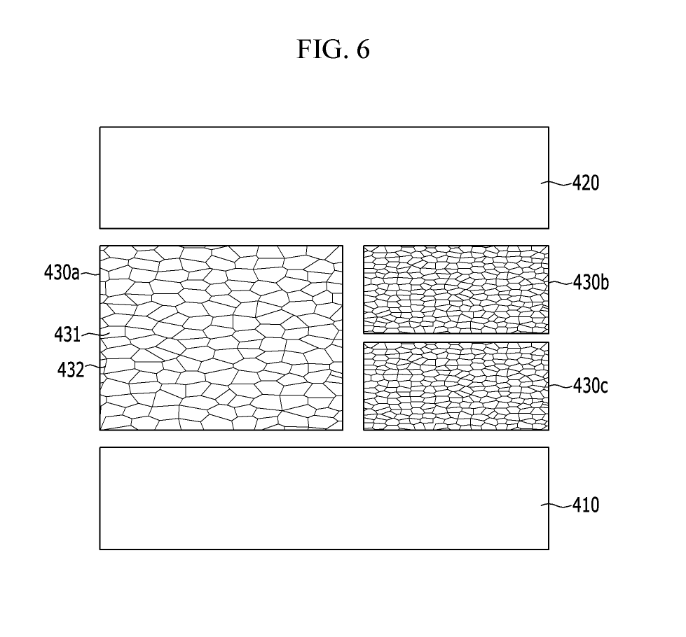

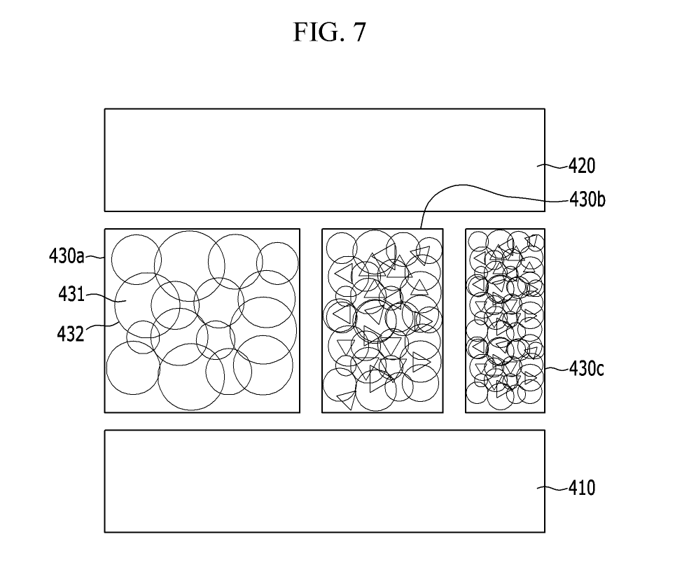

Structures of a dummy electrode 430 according to exemplary embodiments of the present invention will be described with reference to FIGS. 6 and 7.

FIGS. 6 and 7 are diagrams showing dummy electrodes illustrated in part B of FIG. 2.

While the dummy electrode 430 may be formed in one domain at the interval between the first and second touch electrodes 410 and 420 neighboring to each other, the dummy electrodes may also be formed in domains 430a, 430b, and 430c, as shown in FIGS. 6 and 7. The domains 430a, 430b, and 430c may be divided substantially in parallel with or substantially perpendicularly to edges of the first and second touch electrodes 410 and 420 neighboring to each other. The fragment electrodes 431 having random shapes in the dummy electrode 430 may be amorphous, as shown in FIG. 6. In addition, the fragment electrodes 431 may have random polygons including a circle, a triangle, a rectangle, and the like, or have a form in which different polygons are mixed with each other. As described above, the dummy electrode 430 may be formed in any irregular shape and divided into a plurality of domains.

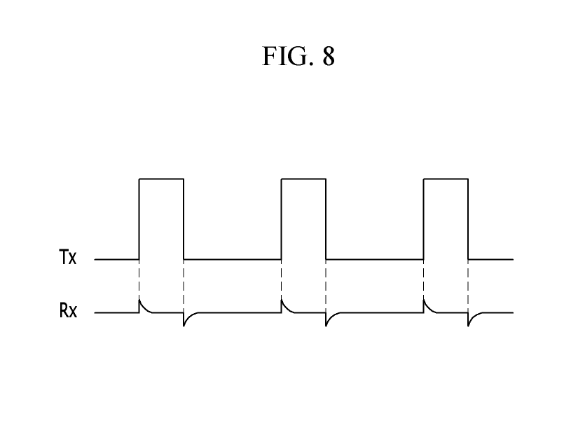

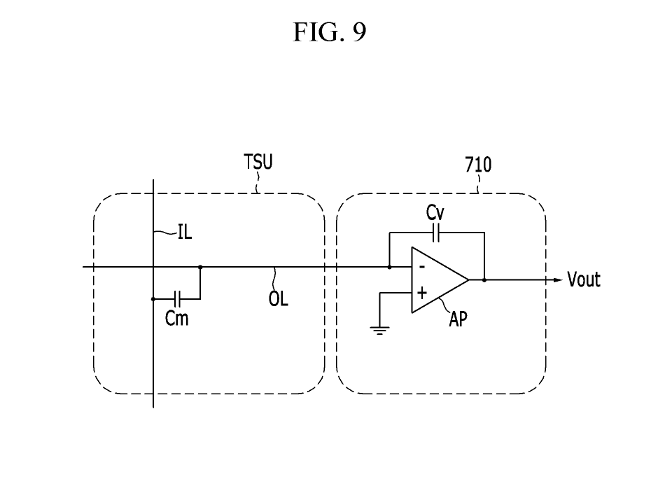

FIG. 8 is a waveform diagram showing a signal applied to a touch sensor according to an exemplary embodiment of the present invention, and FIG. 9 is a circuit diagram of the touch sensor and a touch signal processor according to an exemplary embodiment of the present invention.

Referring to FIG. 8 together with FIG. 1, the first touch electrode 410 may be an input electrode Tx, and the second touch electrode 420 may be an output electrode Rx, or vice versa.

The driving signal is input to the input electrode Tx. The driving signal may have various waveforms and voltage levels, such as to include periodically output pulses and at least two different voltage levels. A direct current (DC) voltage may be applied to the output electrode Rx. For example, a square wave that swings from about 0V to about 3V may be applied to the input electrode Tx, and a DC voltage of about 1.5V may be applied to the output electrode Rx. Even when the DC voltage is applied to the output electrode Rx, a voltage may be varied by coupling with the swinging driving signal. An electric field and a capacitance are generated due to a potential difference between the input electrode Tx and the output electrode Rx, and since a level of a voltage variation of the output electrode Rx is changed when the capacitance is changed by a contact of a finger, a touch pen, or the like, the touch may be sensed based on this change.

As the distance between the input electrode Tx and the output electrode Rx adjacent to each other decreases, the electric field and the capacitance may become larger, and as the distance between the input electrode Tx and the output electrode Rx adjacent to each other increases, the electric field and the capacitance may become smaller. When the capacitance becomes large, a change in the capacitance is small even though a conductive bar or a finger approaches the electrodes, thereby decreasing touch sensitivity. In addition, when the capacitance becomes large, an RC delay of an input signal line is increased, such that a maximum frequency of the driving signal may need to be lowered. When the capacitance becomes small, the touch sensitivity may be increased, and the maximum frequency of the driving signal may be raised.

An operation of a touch sensor will be described in terms of a circuit with reference to FIG. 9. One touch sensor unit TSU that may be formed of one first touch electrode 410 and one second touch electrode 420 shown in FIG. 1. The touch sensor unit TSU may include a sensing capacitor Cm configured of an input line IL that may be the first touch electrode 410 and an output line OL that may be the second touch electrode 420. The sensing capacitor Cm may include an overlap sensing capacitor configured by overlap between the input line IL and the output line OL or a fringe sensing capacitor configured by allowing the input line IL and the output line OL to neighbor to each other without being overlapped with each other.

The touch sensor unit TSU may receive the driving signal transferred by the input line IL and output the change of electric charge of the sensing capacitor Cm by the contact of the external object as the output signal. When the driving signal is input to the touch sensor unit TSU, the sensing capacitor Cm is charged with a predetermined electric charge, and when the contact of the external object is present, the electric charge charged in the sensing capacitor Cm changed, such that a signal corresponding to the change is output to the output line OL. A difference between the output signals in which the object contacts the touch panel and in which the object does not contact the touch panel may be substantially proportional to a change of electric charge in the sensing capacitor Cm.

A signal processor 710 of the touch sensor may receive the output signal from the output line OL and process the output signal to generate touch information such as whether or not a touch is made, a touch position, and the like. The signal processor 710 may include amplifiers AP connected to the output line OL. The amplifier AP may include a capacitor Cv connected between an inverting terminal “−” and an output terminal thereof. A non-inverting terminal “+” of the amplifier AP is connected to a predetermined voltage such as a ground voltage, or the like, and the inverting terminal “−” thereof is connected to the output line OL. The amplifier AP, which is an integrator, may integrate the output signal from the output line OL for a predetermined time (for example, one frame) to generate a detection signal Vout.

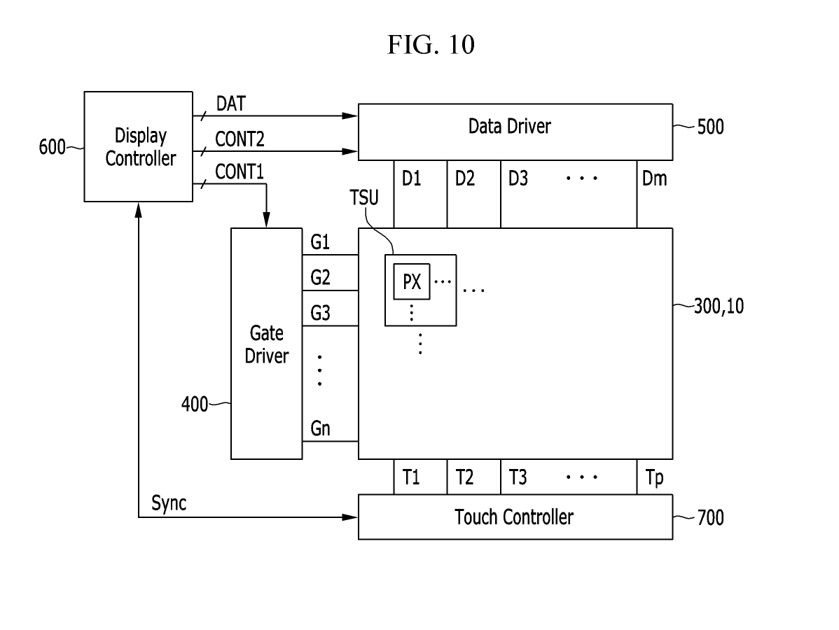

FIG. 10 is a layout diagram of a display device including the touch panel according to an exemplary embodiment of the present invention.

Referring to FIG. 10, a display device including a touch panel according to an exemplary embodiment of the present invention may include a display panel 300, a gate driver 400, a data driver 500 connected to the display panel 300, and a display controller 600 controlling the gate driver 400 and the data driver 500. The display device further includes a touch panel 10 and a touch controller 700 controlling the touch panel 10. Although the touch panel 10 in which the touch electrodes are formed may be attached onto an outer surface of the display panel 300, the touch electrodes may be directly formed on the display panel 300 or in the display panel 300, such that the display panel 300 may become the touch panel 10.

The display panel 300 includes gate lines G1 to Gn, data lines D1 to Dm, and pixels PXs connected to the gate lines G1 to Gn and the data lines D1 to Dm and arranged in an approximately matrix form. The touch panel 10 includes touch signal lines T1 to Tp and touch sensor units TSUs connected to the touch signal lines T1 to Tp and arranged in an approximately matrix form. The touch sensor units TSUs are formed by the first and second touch electrodes 410 and 420 described above.

The gate lines G1 to Gn extend in an approximately horizontal direction and transfer gate signals including gate-on voltages turning on switching devices such as thin-film transistors (TFTs) connected to the respective pixels PXs and gate-off voltages turning off the switching devices. The data lines D1 to Dm extend in an approximately vertical direction and transfer data voltages. When the switching devices are turned on depending on the gate-on voltages, the data voltages applied to the data lines are applied to the pixels.

The pixel PX is a minimum unit displaying an image, and one pixel may unique display one of primary colors or a plurality of pixels may alternately display the primary colors over time to display a desired color by the spatial and temporal sum of these primary colors. A common voltage and the data voltages are applied to each pixel PX.

The touch signal lines T1 to Tp are connected to the touch sensor units TSUs to transfer driving signals and output signals to the touch sensor units TSUs. Some of the touch signal lines T1 to Tp may be input lines transferring the driving signals to the touch sensor units TSUs, and the others thereof may be output lines transferring the output signals from the touch sensor units TSUs.

The touch sensor units TSUs may generate the output signals depending on a touch in a mutual capacitance scheme. The touch sensor units TSUs may receive the driving signals from the touch signal lines T1 to Tp and output the output signals based on the change in the capacitance by the touch of the external object such as the finger, the pen, or the like, through the touch signal lines T1 to Tp. The touch sensor units TSUs may also be operated in a self-capacitance scheme.

The display controller 600 may receive input image signals R, G, and B from an external graphic processor (not shown) and control signals CONT of the input image signals, such as a horizontal synchronization signal Hsync, a vertical synchronization signal Vsync, a clock signal CLK, a data enable signal DE, and the like. The display controller 600 processes the image signals R, G, and B based on the image signals R, G, and B and the control signals CONT to correspond to the operation condition of the display panel 300 and then generates and outputs image data DAT, gate control signals CONT1, data control signals CONT2, and clock signals. The display controller 600 may output synchronization signals Sync to the touch controller 700 and receive touch information from the touch controller 700.

The gate control signal CONT1 includes a start pulse vertical signal SVT indicating a start of the gate signal and a clock pulse vertical signal CPV that may be a reference in generating the gate-on voltage. An output period of the start pulse vertical signal SVT coincides with 1 frame (or refresh rate). The gate control signal CONT1 may further include an output enable signal OE defining a duration of the gate-on voltage.

The data control signal CONT2 includes a start pulse horizontal signal STH indicating a transmission start of the image data DAT for pixels in one row, a load signal TP allowing corresponding data voltages to be applied to the data lines D1 to Dm. When the display panel 300 is a liquid crystal display panel, the data control signals CONT2 may further include a reversion signal RVS reversing a polarity of the data voltage for the common voltage.

The gate driver 400 applies the gate signals, which are the gate-on voltages and the gate-off voltages, to the gate lines G1 to Gn depending on the gate control signals CONT1.

The data driver 500 receives the data control signal CONT2 and the image data DAT from the display controller 600, converts the image data DAT into a data voltage using a grayscale voltage generated in a grayscale voltage generator (not shown), and applies the data voltage to the data line D1 to Dm.

The touch controller 700 transmits input signals to the touch sensor units TSUs and receives output signals from the touch sensor units TSUs to generate the touch information. The touch controller 700 may include a signal processor 710 processing the output signals from the touch sensor units TSUs.

Although certain exemplary embodiments and implementations have been described herein, other embodiments and modifications will be apparent from this description. Accordingly, the inventive concept is not limited to such exemplary embodiments, but rather to the broader scope of the presented claims and various obvious modifications and equivalent arrangements.

What is claimed is:

1. A touch panel, comprising:
a substrate;
touch electrodes disposed on the substrate; and
dummy electrodes disposed on the substrate and between adjacent touch electrodes, wherein the dummy electrodes comprise fragment electrodes.

2. The touch panel of claim 1, wherein the fragment electrodes have random shapes.

3. The touch panel of claim 2, wherein the random shapes are amorphous.

4. The touch panel of claim 2, wherein the shapes are random polygonal shapes.

5. The touch panel of claim 2, wherein the fragment electrodes have a size in a range of several micrometers to several tens of micrometers.

6. The touch panel of claim 2, wherein:
the dummy electrodes comprise gaps disposed between the fragment electrodes; and
the fragment electrodes are separated from each other by the gaps.

7. The touch panel of claim 6, wherein the gaps have a size of several micrometers.

8. The touch panel of claim 1, wherein:
the dummy electrodes are divided into domains; and
each domain comprises the fragment electrodes.

9. The touch panel of claim 1, wherein:
the touch electrodes comprise first and second touch electrodes configured to form mutual sensing capacitors; and
the dummy electrodes are disposed between the first and second touch electrodes.

10. A display device, comprising:
a display panel comprising pixels;
a touch panel comprising touch sensors, the touch sensors comprising touch electrodes and dummy electrodes disposed between adjacent touch electrodes;
a display controller configured to control the display panel; and
a touch controller configured to control the touch panel,
wherein the dummy electrodes comprise fragment electrodes.

11. The display device of claim 10, wherein the fragment electrodes have random shapes.

12. The display device of claim 11, wherein the random shapes are amorphous.

13. The display device of claim 11, wherein the random shapes are random polygonal shapes.

14. The display device of claim 11, wherein the fragment electrodes have a size in a range of several micrometers to several tens of micrometers.

15. The display device of claim 11, wherein:
the dummy electrodes comprise gaps disposed between the fragment electrodes; and
the fragment electrodes are separated from each other by the gaps.

16. The display device of claim 15, wherein the gaps have a size of several micrometers.

17. The display device of claim 10, wherein:
the dummy electrodes are divided into domains; and
each domain comprises the fragment electrodes.

18. The display device of claim 10, wherein:
the touch electrodes comprise first and second touch electrodes configured to form mutual sensing capacitors; and
the dummy electrodes are disposed between the first and second touch electrodes.

19. The display device of claim 9, wherein:
the dummy electrodes comprise the same material as the first and second touch electrodes; and
the dummy electrodes are configured to be in an electrically floated state.

20. The display device of claim 18, wherein:
the dummy electrodes comprise the same material as the first and second touch electrodes; and
the dummy electrodes are configured to be in an electrically floated state.
